(19) United States
(12) Patent Application Publication
(10) Pub. No.: US 2009/0014908 A1
(43) Pub. Date: Jan. 15, 2009

(54) Device and a Method for Manufacturing Three-Dimensional Component Parts

(76) Inventors: Thomas Himmer, Dresden (DE); Anja Techel, Cossebaude (DE)

Correspondence Address: MARSHALL & MELHORN, LLC, FOUR SEAGATE - EIGHTH FLOOR, TOLEDO, OH, 43604, US

(21) Appl. No.: 12/238,913

(22) Filed: Sep. 26, 2008

Related U.S. Application Data
(62) Division of application No. 10/794,936, filed on Mar. 5, 2004.

(30) Foreign Application Priority Data
Mar. 7, 2003 (DE) 103 10 987.0

(51) Int. Cl. B29C 37/00

(52) U.S. Cl. 264/238

(57) ABSTRACT

The invention relates to a device as well as a method for manufacturing three-dimensional component parts wherein machining is carried out at least partially. In accordance with the object, such three-dimensional component parts are allowed to be manufactured in a cost-effective manner with most different contours or contour elements simultaneously with increased manufacturing accuracy. The device according to the invention is then configured such that directly in a machine tool a mold being open towards at least one machining tool is supportedly arranged in a chuck. Thus, machining of a material cured in the mold can be carried out without demolding in the meantime.

### CROSS-REFERENCE TO RELATED APPLICATIONS

This application is a divisional of U.S. application Ser. No. 10/794,936, filed on Mar. 5, 2004. U.S. Ser. No. 10/794,936 was pending as of the filing date of the present application, and is hereby incorporated by reference in its entirety herein.

### BACKGROUND OF THE INVENTION

The invention relates to a device as well as a method for manufacturing three-dimensional component parts wherein machining is carried out at least partially.

With the invention, different component parts, for example master forms, tools or tool inserts can be manufactured. However, it may also be employed for manufacturing small and medium batch sizes wherein the correspondingly manufactured component parts may also have complicated contours at least in defined surface areas.

Usually, three-dimensional component parts are manufactured using different technologies.

Thus, a three-dimensional component part is allowed to be manufactured solely by machining, for example, wherein according to principle at least one surface area either cannot be machined by means of machine tools, wherein processing centers are also allowed to come under, or can be machined not until rechucking in the one machine tool or a further machine tool.

However, three-dimensionally designed component parts can be manufactured using conventional casting technologies as well in which a liquid melt is placed into a mold, and a demolding step is carried out after curing. With component parts manufactured with this casting practice, frequently remachining is often required subsequently, e.g. in order to machine defined surfaces or to shape bores or bores with thread as well. For this purpose, the castings are remachined after demolding as a rule after a more or less long transport.

Casting practices wherein component parts can be manufactured more precisely need a high technical system effort. The required molds are expensive, and despite of high efforts it is not possible everywhere to implement geometric forms of design which are formed in complex. During casting it is impossible to form thread structures to such a component part and inside thereof, respectively, as a rule.

In addition, it is disadvantageous with the conventional casting practices that separate mold tools have to be employed frequently which can be assembled in a high precise and true to size manner before filling with melt such that an offset may occur. With the separate mold tools remachining in the juncture area is frequently required as well.

Materials being suitable for casting are often expanding with curing such that a volume increase takes place, or a volume reduction such as shrinking can also take place. This quantity of influence cannot be readily considered sufficiently in advance with the manufacture of mold tools. In addition, these undesired changes of volume in the cured material are not allowed to occur uniformly inside of the component part as well, however, geometric shaping of the respective shape of component part has also a more or less great influence with this.

It cannot be ensured either that component parts manufactured in a casting practice manner are shaped and dimensioned identically such that the component parts manufactured one after the other are not always completely identical, however, which is frequently required.

Additionally, it is not possible to readily ensure that for example mechanical cutting locations such as the bores or grooves which are necessary for a position accuracy joint of further components to and with such a component part, respectively, have been exactly positioned.

This also relates to the frequently insufficient position accuracy of chucking surfaces or chucking points as well for required subsequently machining as the case may be such that positioning errors cannot be avoided there as well.

As a result, it is an object of the invention to suggest possibilities how to enable the manufacture of three-dimensional component parts having most different contours or contour elements in a cost effective manner simultaneously with increased manufacturing accuracy.

### SUMMARY OF THE INVENTION

This object is solved according to at least one embodiment of the [present invention by a device for manufacturing three dimensional component parts by machining, in which, directly in a machine tool, a mold is open towards at least one machining tool and contains a casting as a semi-finished product to be machined, which is arranged as supported in a chuck. A method for accomplishing this object comprises a machining a cured material which is carried out directly in a mold which is open towards at least one tool and directly arranged in a machine tool and chucked therein. The finished component is then demolded. Additional refinements of this object and method are described hereinbelow.

With the solution according to the invention, the advantages of conventional casting practice and machining are combined with each other.

Thus, directly in a conventional machine tool which is suitable for machining a mold is arranged and supported in such a machine tool in a chucked manner.

The mold is open at least on one side such that a casting contained in the mold providing a semi-finished product can be machined.

During the manufacture it is then allowed to proceed such that the casting process for the manufacture of the casting is carried out directly in the machine tool as well. Accordingly, after curing the melt of the material employed for this casting, machining can be carried out wherein such machining is possible at least in the surface area which is exhibited by the open mold. As a rule, it is allowed to start machining appr. 15 minutes after filling the melt depending on the casting material, or earlier as the case may be.

There, the selective material abrasion with a simultaneous formation of desired surface contours as well as formation of bores with internal threads required as the case may be can be carried out.

This is advantageous in particular if this is carried out in a CNC type machine tool. Then, the respective data set for the component part design can be employed to control the machine tool.

The machine tools to be employed according to the invention should be able to perform machining in at least three different axes wherein the possibility for machining in four or five axes increases the flexibility of manufacture. It should also be possible to provide different tools for machining on one machine tool. For example, these can be fed to the drive of a machine tool via an automatedly operated tool changer, and can be removed again therefrom, thus the required exchange of different tools is allowed to be implemented.

However, with the solution according to the invention it is also possible to carry out machining directly on the mold employed using the machine tool before a casting is cast inside of the mold.

This is advantageous in particular if employing a mold which is formed of plate shaped elements arranged on top of each other. Such plate shaped elements may preferably comprise apertures obtained by means of laser cutting or water jet cutting, wherein the inner contour of the mold can be designed in the form of a correspondingly shaped cavity by means of the apertures. On that occasion, the individual apertures in different planes are allowed to be differently dimensioned and shaped such that a corresponding mold is formed by means of the plate-shaped elements stacked one upon another and joined with each other in a form-fit manner and/or a closure by adhesive force manner.

An equivalent possibility of the manufacture and formation of such molds formed from such plate-shaped elements or of other component parts is described in DE 102 10 420 or DE 102 11 511 as well.

The cavity thus formed is then allowed to be machined on its surface in order to be able to form junctions or rounding radii suitable for casting as well as forming slants to such a mold as well as for a conventional mold.

In case, if the component parts to be manufactured using the invention are not readily accessible to machining at least in the area of the mold, then such correspondingly dimensioned and contoured inserts can be inserted by means of which such undercuts on the component part can be formed already during casting.

However, it is also possible to manufacture such undercuts on correspondingly shaped component parts by means of molds made of silicone or such ones which are formed at least partly from silicone.

With the solution according to the invention manufacturing costs for comparatively complex shaped three-dimensional component parts can be reduced wherein this can be achieved at least by correspondingly reduced costs for the molds since splitted molds are not required in particular.

Another significant advantage consists in the increased manufacturing accuracy since machining is achieved directly inside the mold, and consequently rechucking or remounting is not required.

Due to the mold being open at least on one side the volume change of the component part material caused by shrinking or expanding after curing has an effect which is less than is the case with the splitted molds. This is advantageous in particular with the use of molds made of silicone or in comparison with vacuum casting methods. In addition, thus cavitation forming can be avoided.

With the molds being open upwardly it is possible to refrain from expensive forming of lugs and open feeders. Unfavorable turbulences do not occur during casting, and thus a homogeneous cast body which does not have any air inclusions can be provided.

With the solution according to the invention, the different and even complex geometrical configurations, contours or construction elements can be manufactured in a set-up by means of suitable tools for machining. Thus, threads can be manufactured in a high precise manner and are allowed to be very properly positioned and aligned.

With the component parts manufactured according to the invention, very close tolerances can be kept.

The three-dimensional component parts to be manufactured correspondingly can be fabricated directly such that any previous constructing of a master form is not required. It is possible to form plane surfaces by machining as well as curved contours using cherry and torus milling tools.

With the invention, modified component parts, master forms or prototypes can be flexibly provided in a cost-effective manner and with low effort in a short time. Thus, e.g. an optimum selection can be achieved with a plurality of modified master forms.

Such geometrical changes as well as the changed contours can be obtained by machining or else by deposition welding. Deposition welding can be carried out directly in close proximity to the machine tool as well. On that occasion, areas of the mold are allowed to be correspondingly varied geometrically, or preferably wear can also be compensated with subsequently machining.

Then, it is also possible to couple parts with a mold by means of welding in a closure by adhesive force manner. Thus, a greater influence of the contours of component parts can be achieved by corresponding parts. It is also possible to couple hollow parts, e.g. tubes, with the mold or to insert therein in order to form cooling channels, for example.

### BRIEF DESCRIPTION OF THE DRAWINGS

In the following, the invention shall be explained more closely by way of example.

FIG. 1 shows an embodiment of a mold in a perspective view;

FIG. 2 shows the mold according to FIG. 1 with a casting contained therein;

FIG. 3 shows a component part being machined in the mold;

FIG. 4 shows the demolded component part according to FIG. 3; and

FIG. 5 shows two perspective views of a component part being manufactured according to the invention, and of the corresponding mold.

### DETAILED DESCRIPTION OF THE PREFERRED EMBODIMENT

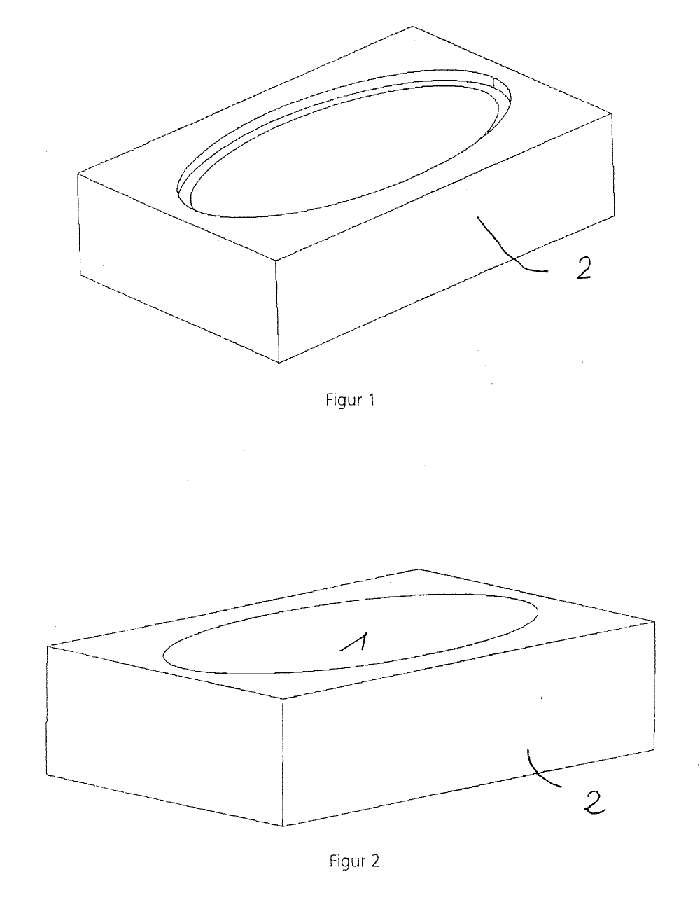

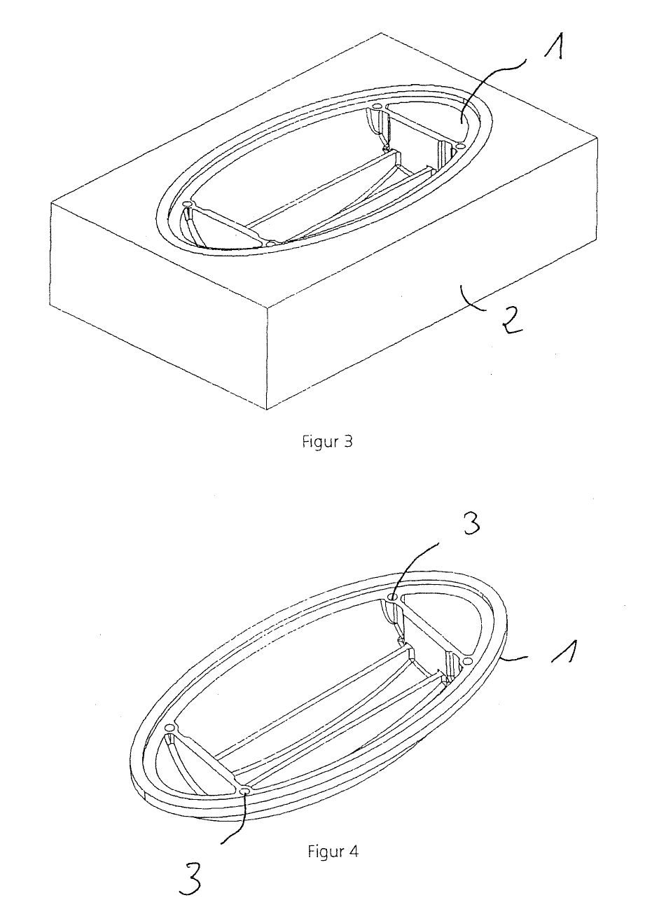

In FIG. 1 a mold 2 which has been previously machined by milling is shown in a perspective view.

This mold 2 could have been machined in the machine tool which is not shown herein for machining a three-dimensional component part to be manufactured.

Then, the chuck should also be used and maintained during a subsequent casting step wherein the cavity of mold 2 is to be filled with the liquid melt of a suitable material.

Mold 2 containing a casting 1 after curing the melt is shown in a perspective view as well.

FIG. 3 shows the result of machining the casting 1 inside of the mold 2 after machining has taken place during which the most different contour configurations have been formed.

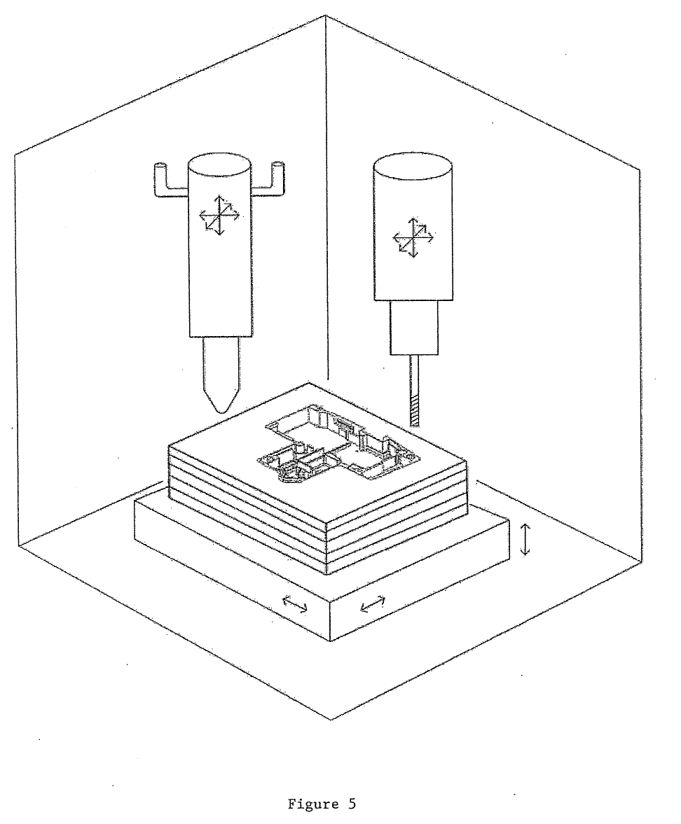

Bores with internal threads 3 manufactured by machining have also been formed in the component part. The component part manufactured according to the invention after demolding is shown in FIG. 4.

In FIG. 5, two perspective views of another three-dimensional component part 1 manufactured according to the invention have been illustrated with the corresponding mold 2.

On that occasion, fine component part contouring which can be manufactured according to the invention is to be taken in particular from the upper representation of FIG. 5.

What is claimed is:

1. A method for manufacturing three dimensional component parts in a machine tool for manufacturing three dimensional component parts by machining, comprising:
arranging and supporting a mold in the machine tool in a chucked manner, wherein the mold is open at least on one side such that a casting provided as a semi-finished product and being contained in the mold can be machined;
casting by filling a cavity of the mold with a liquid melt in order to manufacture a casting, wherein the chucking is maintained during the casting process and wherein the casting process is carried out directly in the machine tool;
machining, after curing the liquid melt of the material employed for casting, the casting directly inside the mold so that rechecking is not required; and
subsequently demolding the machined casting.

2. The method according to claim 1, further comprising machining an inner contour of the mold using the machine tool before filling the mold with molten material.

3. The method according to claim 1, wherein for manufacturing component parts which have undercuts in the area of the mold, inserts of those manufacturing components are inserted into the mold.

4. The method according to claim 1, wherein the molds used for manufacturing component parts comprise silicone.
